(19) United States
(12) Patent Application Publication
(10) Pub. No.: US 2021/0190023 A1
(43) Pub. Date: Jun. 24, 2021

(54) BOLT STYLE SUSPENDED FUEL INJECTOR

(71) Applicants: DENSO International America, Inc., Southfield, MI (US); DENSO CORPORATION, Aichi (JP)

(72) Inventors: Thaier SHAEENA, Southfield, MI (US); Jeffrey HAFNER, Southfield, MI (US); Aleksandr VARTANIAN, Southfield, MI (US); Zachary WILSON, Southfield, MI (US); Steven ROSEBORSKY, Kingsville (CA)

(73) Assignees: DENSO International America, Inc., Southfield, MI (US); DENSO CORPORATION, Aichi (JP)

(21) Appl. No.: 16/721,522

(22) Filed: Dec. 19, 2019

(51) Int. Cl. F02M 55/00; F02M 55/02; F02M 59/48

(52) U.S. Cl. CPC F02M 55/004; F02M 55/025; F02M 2200/858; F02M 2200/856; F02M 59/48

(57) ABSTRACT

A fuel injector assembly includes a fuel cup, a fuel injector, and a bolt. The fuel cup defines a cavity and a cup inlet. The fuel injector includes an injection tip and an upper housing. The injection tip defines a fuel outlet opposite the upper housing. The upper housing defines a fuel inlet and a threaded bore. The fuel inlet is disposed within the cavity and in fluid communication with the cup inlet. The threaded bore is disposed within the fuel cup. The bolt is threadably engaged with the threaded bore. The bolt couples the upper housing to the fuel cup.

### FIELD

The present disclosure relates to suspended fuel injectors.

### BACKGROUND

The statements in this section merely provide background information related to the present disclosure and may not constitute prior art.

Internal combustion engines typically have a fuel rail that supplies fuel to fuel injectors. The fuel injectors have a tip that extends through an aperture in the cylinder head. The tip is configured to selectively emit fuel into the combustion chamber of the engine. The tip can be configured to emit the fuel in a specific direction and spray pattern relative to the combustion chamber such that an incorrect rotational orientation of the tip relative to the cylinder head can result in decreased performance. In typical engine configurations, the fuel rail is affixed to the engine such that the fuel rail presses an end of the fuel injector into contact with the cylinder head to hold the fuel injector in position between the fuel rail and the cylinder head.

### SUMMARY

In one form, the present disclosure provides for a fuel injector assembly including a fuel cup, a fuel injector, and a bolt. The fuel cup defines a cavity and a cup inlet. The fuel injector includes an injection tip and an upper housing. The injection tip defines a fuel outlet opposite the upper housing. The upper housing defines a fuel inlet and a threaded bore. The fuel inlet is disposed within the cavity and in fluid communication with the cup inlet. The threaded bore is disposed within the fuel cup. The bolt is threadably engaged with the threaded bore. The bolt couples the upper housing to the fuel cup.

In another form, the present disclosure provides for a fuel injector assembly including a fuel rail, a fuel cup, a fuel injector, a bolt, and an upper seal. The fuel cup is coupled to the fuel rail. The fuel cup defines a cavity, a bolt bore, and a cup inlet. The bolt bore and cup inlet are open to the cavity. The cup inlet is configured to receive fuel from the fuel rail. The fuel injector includes an injection tip and an upper housing. The injection tip defines a fuel outlet opposite the upper housing. The upper housing defines a fuel inlet and a threaded bore. The fuel inlet is disposed within the cavity and in fluid communication with the cup inlet. The threaded bore is disposed within the fuel cup. The bolt extends through the bolt bore and is threadably engaged with the threaded bore to couple the upper housing to the fuel cup. The upper seal inhibits fluid communication from the cavity to an exterior of the fuel cup via the bolt bore.

In yet another form, the present disclosure provides for a fuel injector including an injection tip and an upper housing. The injection tip defining a fuel outlet. The upper housing is opposite the fuel outlet. The upper housing is disposed about a longitudinal axis of the fuel injector. A distal portion of the upper housing is coupled to the injection tip. The upper housing defines a fuel inlet configured to receive fuel from a fuel rail. A proximal portion of the upper housing defines a threaded bore coaxial with the longitudinal axis.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side view of a fuel injector assembly in accordance with the teachings of the present disclosure, illustrating an orientation member of a first construction in accordance with the teachings of the present disclosure;

FIG. 2 is a perspective view of a portion of the fuel injector assembly of FIG. 1;

FIG. 3 is a perspective view of a portion of a fuel injector assembly similar to that of FIG. 2 but with an orientation member of a second construction in accordance with the teachings of the present disclosure;

FIG. 4 is a cross-sectional view of a portion of the fuel injector assembly of FIG. 3;

FIG. 5 is a perspective cross-sectional view of a portion of a fuel injector assembly of a third construction in accordance with the teachings of the present disclosure;

FIG. 6 is a cross-sectional view of a portion of a fuel injector assembly of a fourth construction in accordance with the teachings of the present disclosure; and

FIG. 7 is a perspective view of a portion of a fuel injector of a fifth construction in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In some applications, such as some vehicle engines, the contact between the cylinder head and the end of the fuel injector can transmit vibrations through or from the engine. These vibrations can manifest as audible noise or can be transmitted to other components, such as sensors for example, where vibration may be detrimental to performance or longevity of those components.

In an effort to reduce such vibration transmission paths, suspended injectors have been specified for some engine applications in which the suspended fuel injectors do not abut the cylinder head. However, current solutions for affixing a suspended fuel injector between the cylinder head and the fuel rail are complicated and costly.

The present disclosure provides for a suspended fuel injector that overcomes these and other issues with typical fuel injectors.

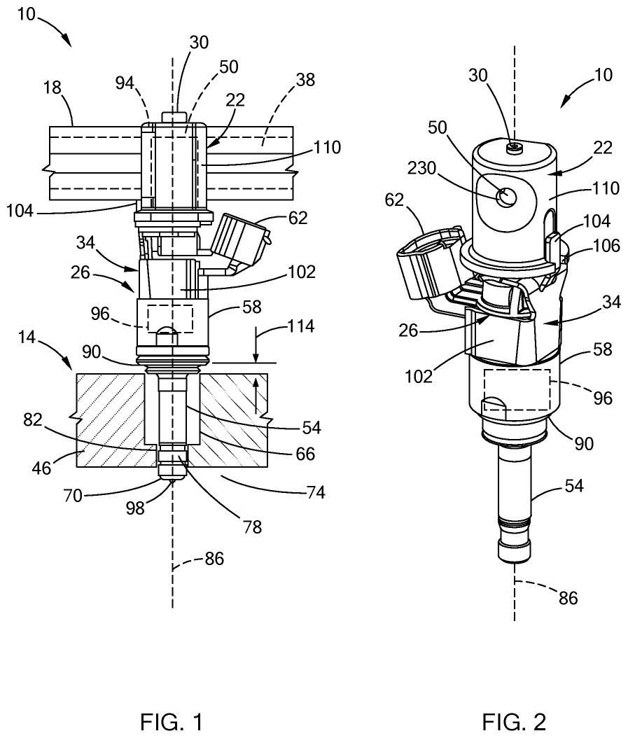

Referring to FIGS. 1 and 2, a fuel injector assembly 10 is illustrated with a portion of an internal combustion engine 14. In the example provided, the internal combustion engine 14 is an engine of a vehicle (not shown), though the engine 14 may be used in other applications (e.g., machinery, generators). Examples of vehicles that may include the engine 14 may include, without limitation, automobiles, trucks, recreational vehicles, watercraft, and all-terrain vehicles. The engine 14 may provide motive power to drive wheels (not shown) of the vehicle such as through a transmission (not shown) of the vehicle for example. Additionally or alternatively, the engine 14 may charge a vehicle battery (not shown) that may supply electric power to electric motors (not shown) that provide some or all of the motive power to the wheels (e.g., an electric or hybrid vehicle).

In the example provided, the engine 14 is a piston-cylinder engine including a combustion chamber 74 at least partially defined by a cylinder head 46 and a piston (not shown). The combustion chamber 74 may also be at least partially defined by a portion of an engine block (not shown) of the engine 14.

The fuel injector assembly 10 generally provides fuel (e.g., gasoline, diesel, ethanol) to the combustion chamber 74. The fuel injector assembly 10 includes a fuel rail 18, a fuel cup 22, a fuel injector 26, and a fastener 30. The fuel injector assembly may also include an orientation member 34. The fuel rail 18 generally receives fuel from a fuel supply system (not shown; e.g., a fuel tank via a fuel pump) and provides the fuel to one or more fuel cups 22 (one of which is illustrated), each of which provides fuel to a corresponding fuel injector 26 (one of which is illustrated). Each fuel injector 26 generally provides fuel to the combustion chamber 74.

More specifically, the fuel rail 18 defines an internal passageway 38 that is connected for fluid communication with the fuel supply system (not shown) and configured to receive fuel from the fuel supply system. The fuel rail 18 is attached to a structure (not shown; e.g., a frame or a part of the engine 14) via one or more brackets (not shown). The fuel rail 18 is attached to the structure (not shown) such that the fuel rail 18 is a fixed distance from the cylinder head 46 of the engine 14.

The fuel cup 22 is coupled to the fuel rail 18 (e.g., brazed or welded thereto) and defines an internal cavity 50 in fluid communication with the internal passageway 38 of the fuel rail 18 such that the fuel cup 22 can receive fuel from the fuel rail 18. While a single fuel cup 22 is illustrated, a plurality of fuel cups 22 may be coupled to the fuel rail 18 along the length of the fuel rail 18 such that each fuel cup 22 can receive fuel from the fuel rail 18.

The fuel injector 26 includes an injection tip 54, an upper housing 58, and an electrical connector 62. The injection tip 54 is received through a bore 66 in the cylinder head 46 such that a terminal end 70 of the injection tip 54 is configured to spray fuel into the combustion chamber 74 of the engine 14. The injection tip 54 may include a seal member 78 configured to form a seal with an inner surface 82 of the bore 66 of the cylinder head 46. The injection tip 54 is disposed about a central axis 86 of the fuel injector 26 and extends longitudinally from a distal portion 90 of the upper housing 58.

A proximal portion 94 of the upper housing 58 is disposed within the fuel cup 22 and configured to receive fuel therefrom. Internal valve components 96 are disposed within the upper housing 58 and configured to selectively release fuel into the combustion chamber 74 via a fuel outlet 98 defined by the terminal end 70 of the injection tip 54. The internal valve components 96 are controlled by power and/or signals received via the electrical connector 62.

The fuel outlet 98 of the injection tip 54 can be configured to produce a specific spray pattern and the orientation member 34 is configured to maintain the fuel injector 26 in a predetermined rotational orientation relative to the combustion chamber 74. In the example provided, the orientation member 34 is a clip that includes legs 102 and a finger 104. The legs 102 engage the upper housing 58 below the fuel cup 22 such that the orientation member does not rotate relative to the upper housing 58. The finger 104 extends into a notch 106 defined by the fuel cup 22 such that the finger inhibits rotation of the fuel injector 26 relative to the fuel cup 22. While shown herein as a clip, other constructions of the orientation member 34 can be used.

The fuel injector assembly 10 is a suspended fuel injection system such that the distal portion 90 of the upper housing 58 does not contact the engine 14. In other words, the upper housing 58 is axially spaced apart from the cylinder head 46 by a gap 114. In the example provided, the orientation member 34 may not be sufficient to maintain the axial position of the fuel injector 26 relative to the cylinder head 46. As described in greater detail below, the fastener 30 (e.g., a bolt or screw) couples the upper housing 58 to the fuel cup 22 to maintain the axial position of the fuel injector 26 relative to the cylinder head 46 and to maintain the gap 114 therebetween.

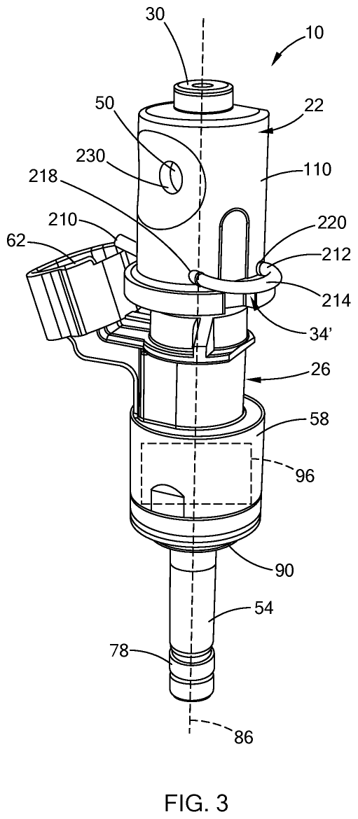

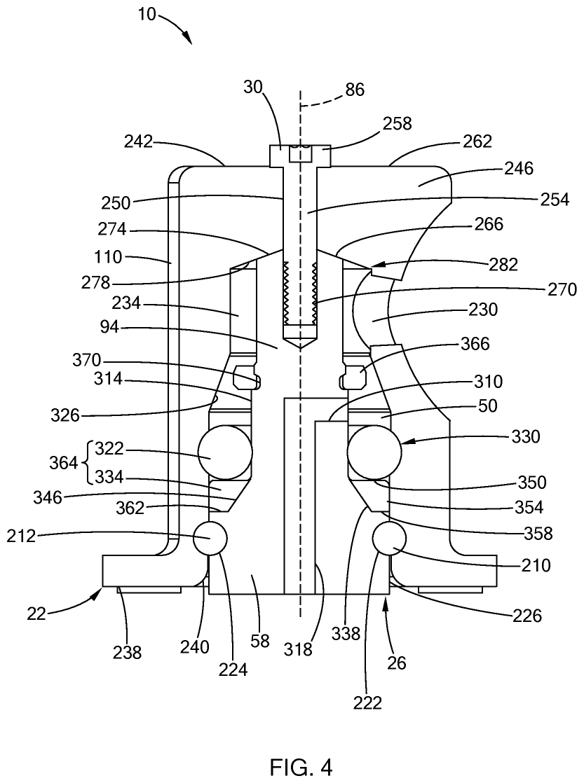

Referring to FIGS. 3 and 4, a portion of a fuel injector assembly 10 of a second construction is illustrated. The fuel injector assembly 10 shown in FIGS. 3 and 4 is similar to the fuel injector assembly 10 shown in FIGS. 1 and 2 except that instead of the clip-type orientation member 34 (FIGS. 1 and 2), the orientation member 34′ includes a pair of prongs 210, 212 that are coupled together on one end 214 to form a generally “U” shaped pin member. The end 214 of the orientation member 34′ is disposed external of the fuel cup 22 and each prong 210, 212 extends through a corresponding aperture 218, 220 in the fuel cup 22. The apertures 218, 220 are parallel to each other, are on opposite sides of the axis 86, and extend longitudinally through the fuel cup 22 into the cavity 50 such that the prongs 210, 212 are perpendicular to the axis 86. In the example provided, the apertures 218, 220 extend fully through the fuel cup 22 such that the prongs 210, 212 exit an opposite side of the fuel cup 22, though other configurations can be used.

In the example provided, the prongs 210, 212 are generally cylindrical in shape, though other configurations can be used. The prongs 210, 212 fit within corresponding channels 222, 224 defined by the upper housing 58 when the fuel injector 26 is positioned in the predetermined rotational orientation. In the example provided the channels 222, 224 are open through a radially outward surface 226 of the upper housing 58.

An outer wall 110 of the fuel cup 22 includes a cup inlet 230 open to the internal passageway 38 of the fuel rail 18 (FIG. 1) and open to a region 234 of the cavity 50 to provide fluid communication between the fuel rail 18 (FIG. 1) and the region 234 of the cavity 50. In the example provided, the cup inlet 230 is perpendicular to the apertures 218, 220, though other configurations can be used.

A bottom end 238 of the fuel cup 22 defines an aperture 240 that is open into the cavity 50 such that the proximal portion 94 of the upper housing 58 of the fuel injector 26 can be inserted into the cavity 50 through the bottom end 238 of the fuel cup 22. A top end 242 of the fuel cup 22 is opposite the bottom end 238 and is generally closed by a top wall 246 of the fuel cup 22. The top wall 246 of the fuel cup 22 defines a fastener bore, referred to herein as a bolt bore 250, open through the top wall 246 and into the cavity 50. The bolt bore 250 is coaxial with the axis 86. The cup inlet 230 is disposed axially between the top wall 246 and the apertures 218, 220. In the example provided, the bolt bore 250 is not threaded and has a diameter greater than threads of an externally threaded portion 254 of the fastener 30 such that the threaded portion 254 can be received through the bolt bore 250 and the fastener 30 is free to rotate in the bolt bore 250 without translating the fastener 30 relative to the fuel cup 22. In the example provided, a head portion 258 of the fastener 30 extends radially outward of the threaded portion 254 and engages a top surface 262 of the top wall 246 of the fuel cup 22.

Returning to the example provided, a terminal end 266 of the proximal portion 94 of the upper housing 58 includes a threaded bore 270 coaxial with the axis 86 and a seal surface 274 disposed about the threaded bore 270. The threaded bore 270 aligns with the bolt bore 250 and the threaded portion 254 of the fastener 30 is received through the bolt bore 250 to threadably engage with the threaded bore 270. The seal surface 274 is configured to engage a mating seal surface 278 defined by the top wall 246 within the cavity 50 to form a fluid-tight seal between the proximal portion 94 and the top wall 246 to inhibit fluid from exiting the fuel cup 22 via the bolt bore 250. In the example provided, the seal surface 274 and the mating seal surface 278 are both metal surfaces to form a metal-to-metal seal therebetween. In the example provided, the seal surface 274 and the mating seal surface 278 are both frustoconically shaped, though other shapes may be used. Thus, the seal surface 274 and the mating seal surface 278 form a first seal 282 between the upper housing 58 and the fuel cup 22.

The fastener 30 can secure the fuel injector 26 to the fuel cup 22 to inhibit axial motion therebetween and maintain the gap 114 (FIG. 1) between the distal portion 90 of the upper housing 58 and the cylinder head 46. An additional thread sealant (not shown) may also optionally be used to seal the threaded portion 254 of the fastener 30 with the bolt bore 250 and/or with the threaded bore 270. In an alternative configuration, not shown, a seal (e.g., a washer or gasket) can optionally form a seal between the head portion 258 of the fastener 30 and the top surface 262 of the top wall 246 of the fuel cup 22 to form a seal therebetween.

Referring specifically to FIG. 4, the upper housing 58 defines a fuel inlet 310 open through a radially outer surface 314 of the upper housing 58. The fuel inlet 310 extends radially inward to a central passageway 318 that provides fuel to the injection tip 54 (FIG. 3) via the internal valve components 96 (FIG. 3). The fuel inlet 310 is open to the region 234 of the cavity 50 such that the fuel inlet 310 is in fluid communication with the cup inlet 230 via the cavity 50.

The fuel injector assembly 10 also includes a first lower seal member 322 disposed within the cavity 50 and axially between the fuel inlet 310 and the open bottom end 238 of the fuel cup 22. The first lower seal member 322 is an annular body (e.g., an O-ring) disposed coaxially about the upper housing 58 and in contact with the radially outer surface 314 of the upper housing 58 and an interior surface 326 of the outer wall 110 of the fuel cup 22 to form a seal therebetween. The first lower seal member 322 inhibits fuel from exiting the cavity via the open bottom end 238 of the fuel cup 22. In the example provided, the first lower seal member 322 is also axially between the fuel inlet 310 and the orientation member 34′ to inhibit fuel from exiting the cavity 50 via the apertures 218, 220 (FIG. 3). Thus, the first lower seal member 322 forms a second seal 330 between the upper housing 58 and the fuel cup 22.

In the example provided, the fuel injector assembly 10 also includes a second lower seal member 334. The second lower seal member 334 is an annular body disposed coaxially about the upper housing 58 and axially between the first lower seal member 322 and the open bottom end 238. The second lower seal member 334 includes a frustoconical surface 338 that defines the central bore of the annular second lower seal member 334 such that the central bore of the annular second lower seal member 334 has a smaller diameter proximate to the first lower seal member 322 and a larger diameter proximate to the open bottom end 238. The upper housing 58 defines a mating frustoconically shaped surface 346 that contacts and seals with the frustoconical surface 338 of the second lower seal member 334.

An upper surface 350 of the second lower seal member 334 can contact and seal with the first lower seal member 322. A radially outward surface 354 of the second lower seal member 334 can seal with the interior surface 326 of the outer wall 110 of the fuel cup 22. In the example provided, the frustoconical surface 338 does not widen all the way to the radially outward surface 354. In other words, a lower surface 358, which can be parallel to the upper surface 350, extends radially outward between the frustoconical surface 338 and the radially outward surface 354. The lower surface 358 is seated on and can seal with a shoulder 362 of the upper housing 58 that extends radially outward from the radially outward surface 354. Thus, the second lower seal member 334 can form a back-up seal for the first lower seal member 322 and the first and second lower seal members 322 and 334 can cooperate to form a lower seal assembly 364.

In the example provided, the fuel injector 10 may optionally include a stopper ring 366. The stopper ring 366 can be a snap-on ring or c-clip partially received in a circumferential groove 370 recessed radially inward from the radially outward surface 314. The stopper ring 366 can act to inhibit the first and second lower seal members 322, 334 from translating off of the proximal portion 94.

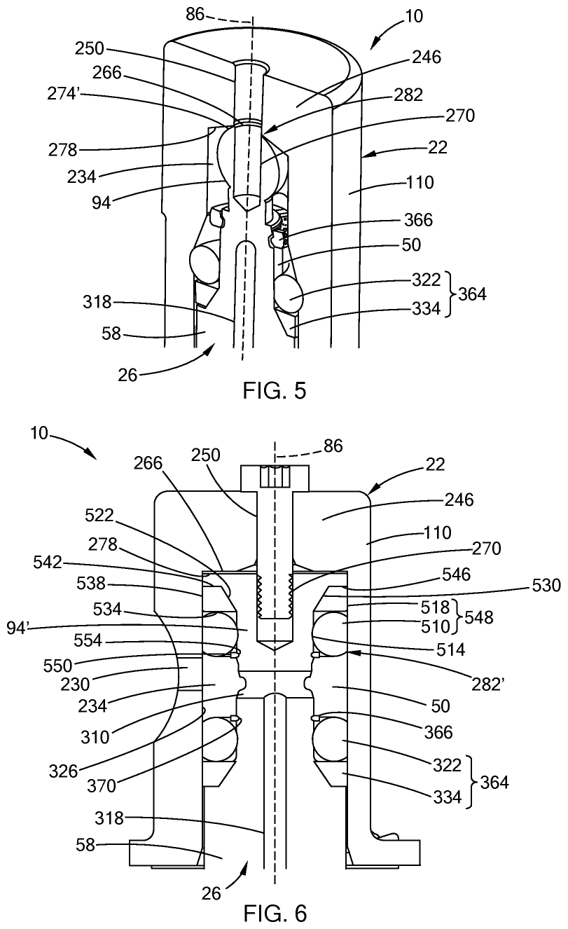

Referring to FIG. 5, a portion of a fuel injector assembly 10 of a third construction is illustrated. The fuel injector assembly 10 of FIG. 5 is similar to the fuel injector assemblies 10 of FIGS. 1-4, except as otherwise shown or described herein. Specifically, the seal surface 274′ of the fuel injector assembly 10 of FIG. 5 is a convex spherically shaped surface instead of the frustoconical shape of the fuel injector assembly 10 of FIG. 4. The spherically shaped seal surface 274′ can mate with the frustoconically shaped mating seal surface 278 of the fuel cup 22. In an alternative configuration, not specifically shown, the mating seal surface 278 may be another shape, such as flat or concave spherical. While not specifically shown, the seal surface 274′ and/or the mating seal surface 278 can be any suitable mating shape for forming a direct contact fluid seal.

Referring to FIG. 6, a portion of a fuel injector assembly 10 of a fourth construction is illustrated. The fuel injector assembly 10 of FIG. 6 is similar to the fuel injector assembly 10 of FIGS. 1-5, except as otherwise shown or described herein. Specifically, the proximal portion 94′ of the upper housing 58 of FIG. 6 may or may not include the seal surface 274 (FIG. 4) that engages the mating seal surface 278 (FIG. 4). In the example shown, the proximal portion 94′ does not include the seal surface 274 (FIG. 4) and the proximal portion 94′ does not directly contact the top wall 246 of the fuel cup 22. Instead, a first upper seal member 510 forms the first seal 282′ between the upper housing 58 and the fuel cup 22. The first upper seal member 510 is an annular body (e.g., an O-ring) disposed coaxially about the upper housing 58 and disposed axially between the fuel inlet 310 and the terminal end 266 of the proximal portion 94. The first upper seal member 510 contacts a radially outward surface 514 of the upper housing 58 and the interior surface 326 of the outer wall 110 of the fuel cup 22 to form a seal therebetween to inhibit fuel from reaching the fastener and exiting via the bolt bore 250.

In the example provided, the fuel injector assembly 10 of FIG. 6 also includes a second upper seal member 518. The second upper seal member 518 is an annular body disposed coaxially about the upper housing 58 and axially between the first upper seal member 510 and the terminal end 266 of the proximal portion 94. The second upper seal member 518 includes a frustoconical surface 522 that defines the central bore of the annular second upper seal member 518 such that the central bore of the annular second upper seal member 518 has a smaller diameter proximate to the first upper seal member 510 and a larger diameter proximate to the terminal end 266 of the proximal portion 94. The upper housing 58 defines a mating frustoconically shaped surface 530 that contacts and seals with the frustoconical surface 522 of the second upper seal member 518.

A lower surface 534 of the second upper seal member 518 can contact and seal with the first upper seal member 510. A radially outward surface 538 of the second upper seal member 518 can seal with the interior surface 326 of the outer wall 110 of the fuel cup 22. In the example provided, the frustoconical surface 522 does not widen all the way to the radially outward surface 538. In other words, an upper surface 542, which can be parallel to the lower surface 534, extends radially outward between the frustoconical surface 522 and the radially outward surface 538. The upper surface 542 is seated on and can seal with a shoulder 546 of the fuel cup 22. Thus, the second upper seal member 518 can form a back-up seal for the first upper seal member 510 and the first and second upper seal members 510 and 518 can cooperate to form an upper seal assembly 548.

In the example provided, the fuel injector 10 may optionally include the lower stopper ring 366. The stopper ring 366 can be a snap-on ring or c-clip partially received in the circumferential groove 370 recessed radially inward from the radially outward surface 314. The stopper ring 366 can be between the fuel inlet 310 and the first lower seal member 322 to act to inhibit the first and second lower seal members 322, 334 from translating upwards relative to the proximal portion 94′. The fuel injector 10 may also optionally include an upper stopper ring 550. The upper stopper ring 550 can be a snap-on ring or c-clip partially received in a circumferential groove 554 recessed radially inward from the radially outward surface 514. The upper stopper ring 550 can be between the fuel inlet 310 and the first upper seal member 510 to act to inhibit the first and second upper seal members 510, 518 from translating downwards relative to the proximal portion 94.

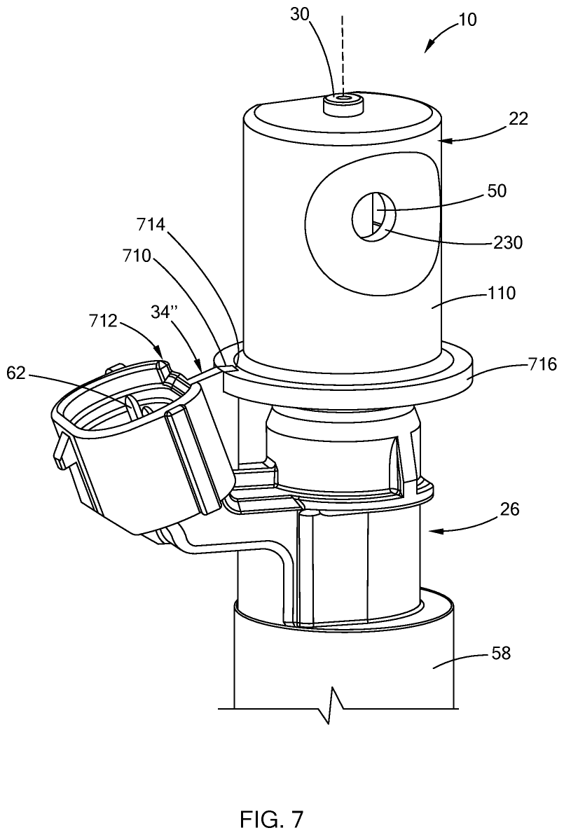

Referring to FIG. 7, a portion of a fuel injector assembly 10 of a fifth construction is illustrated. The fuel injector assembly 10 of FIG. 7 is similar to the fuel injector assembly 10 of FIGS. 1-6, except as otherwise shown or described herein. Specifically, instead of the clip-type orientation member 34 (FIGS. 1 and 2) or the pin-type orientation member 34′ (FIGS. 3 and 4), the orientation member 34″ is integrally formed with the upper housing 58. In the example provided, the orientation member 34″ is a protrusion or fin 710 that extends from a portion 712 of the upper housing 58 that forms part of the electrical connector 62. The fin 710 has a shape that fits within a slot 714 defined by the fuel cup 22. In the example provided, the slot 714 is defined by a rim 716 of the fuel cup 22 that extends radially outward of the outer wall 110, though other configurations can be used. The fin 710 can only fit within the slot 710 when the fuel injector 26 is correctly oriented. The fin 710 cooperates with the slot 710 to inhibit rotation of the fuel injector 26 relative to the fuel cup 22.

In an alternative configuration, not specifically shown, the fin 710 can extend from a different part of the upper housing 58. In another alternative configuration, not specifically shown, the fuel cup 22 can have a protrusion or fin that fits within a slot defined by the upper housing 58.

Based on the foregoing, in one form, the present disclosure is directed toward a fuel injector assembly which includes a fuel cup, a fuel injector, and a bolt. The fuel cup defines a cavity and a cup inlet. The fuel injector includes an injection tip and an upper housing. The injection tip defines a fuel outlet opposite the upper housing. The upper housing defines a fuel inlet and a threaded bore. The fuel inlet is disposed within the cavity and in fluid communication with the cup inlet. The threaded bore is disposed within the fuel cup. The bolt is threadably engaged with the threaded bore. The bolt couples the upper housing to the fuel cup.

In one form, the fuel cup defines a bolt bore aligned with the threaded bore. The bolt extends through the bolt bore to engage the threaded bore.

In another form, a surface of the upper housing contacts a surface of the fuel cup to define an upper seal that isolates the bolt bore from fluid communication with the fuel inlet.

In yet another form, the fuel injector assembly further includes an upper seal between the upper housing and the fuel cup. The upper seal isolates the threaded bore from fluid communication with the fuel inlet.

In still another form, the upper housing defines a seal surface disposed about the threaded bore that contacts a mating seal surface of the fuel cup to form the upper seal.

In another form, the fuel injector assembly further includes a first upper seal member disposed about the upper housing. The first upper seal member contacts the upper housing and the fuel cup to form the upper seal.

In yet another form, the first upper seal member is a resilient material.

In still another form, the fuel injector assembly further includes a second upper seal member disposed about the upper housing. The second upper seal member contacts the upper housing and the fuel cup to form a second upper seal between the upper housing and the fuel cup. The first upper seal is axially between the fuel inlet and the second upper seal.

In another form, the fuel injector assembly further includes a lower seal between the upper housing and the fuel cup. The fuel inlet is disposed between the upper seal and the lower seal.

In yet another form, the fuel injector assembly further includes a first lower seal member disposed about the upper housing. The first lower seal member contacts the upper housing and the fuel cup to form the lower seal. The first lower seal member is a resilient material.

In still another form, the fuel injector assembly further includes a second lower seal member disposed about the upper housing. The second lower seal member contacts the upper housing and the fuel cup to form a second lower seal between the upper housing and the fuel cup. The first lower seal is axially between the fuel inlet and the second lower seal.

In another form, the threaded bore is coaxial with a longitudinal axis of the fuel injector.

In still another form, the fuel injector assembly further includes an orientation member. The orientation member engages the fuel cup and the upper housing to inhibit rotation of the fuel injector relative to the fuel cup.

In yet another form, the fuel cup defines an orientation aperture open through an exterior wall of the fuel cup. The orientation member extends through the orientation aperture and engages the upper housing within the fuel cup when the upper housing is in a predetermined rotational alignment with the fuel cup.

In another form, the fuel injector assembly further includes an upper seal and a lower seal. The upper seal isolates the threaded bore from fluid communication with the fuel inlet. The lower seal isolates the orientation member from fluid communication with the fuel inlet.

In a further form, the disclosure is directed toward a fuel injector assembly which includes a fuel rail, a fuel cup, a fuel injector, a bolt, and an upper seal. The fuel cup is coupled to the fuel rail. The fuel cup defines a cavity, a bolt bore, and a cup inlet. The bolt bore and cup inlet are open to the cavity. The cup inlet is configured to receive fuel from the fuel rail. The fuel injector includes an injection tip and an upper housing. The injection tip defines a fuel outlet opposite the upper housing. The upper housing defines a fuel inlet and a threaded bore. The fuel inlet is disposed within the cavity and in fluid communication with the cup inlet. The threaded bore is disposed within the fuel cup. The bolt extends through the bolt bore and is threadably engaged with the threaded bore to couple the upper housing to the fuel cup. The upper seal inhibits fluid communication from the cavity to an exterior of the fuel cup via the bolt bore.

In another form, the fuel injector assembly further includes a lower seal between the upper housing and the fuel cup. The fuel inlet is axially between the upper seal and the lower seal.

In still a further form, the disclosure is directed toward a fuel injector including an injection tip and an upper housing. The injection tip defining a fuel outlet. The upper housing is opposite the fuel outlet. The upper housing is disposed about a longitudinal axis of the fuel injector. A distal portion of the upper housing is coupled to the injection tip. The upper housing defines a fuel inlet configured to receive fuel from a fuel rail. A proximal portion of the upper housing defines a threaded bore coaxial with the longitudinal axis.

In yet another form, the fuel injector further includes a seal surface disposed about the threaded bore and configured to sealingly engage a fuel cup.

In still another form, the fuel injector further includes an upper seal member and a lower seal member. The upper seal member is disposed about the upper housing and configured to form a seal with a fuel cup. The lower seal member is disposed about the upper housing and configured to form a seal with the fuel cup. The fuel inlet is disposed axially between the upper and lower seal members.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A fuel injector assembly comprising:
a fuel cup defining a cavity and a cup inlet;
a fuel injector including an injection tip and an upper housing, the injection tip defining a fuel outlet opposite the upper housing, the upper housing defining a fuel inlet and a threaded bore, wherein the fuel inlet is disposed within the cavity and in fluid communication with the cup inlet, wherein the threaded bore is disposed within the fuel cup; and
a bolt threadably engaged with the threaded bore, the bolt coupling the upper housing to the fuel cup.

2. The fuel injector assembly according to claim 1, wherein the fuel cup defines a bolt bore aligned with the threaded bore, the bolt extending through the bolt bore to engage the threaded bore.

3. The fuel injector assembly according to claim 2, wherein a surface of the upper housing contacts a surface of the fuel cup to define an upper seal that isolates the bolt bore from fluid communication with the fuel inlet.

4. The fuel injector assembly according to claim 1 further comprising an upper seal between the upper housing and the fuel cup, the upper seal isolating the threaded bore from fluid communication with the fuel inlet.

5. The fuel injector assembly according to claim 4, wherein the upper housing defines a seal surface disposed about the threaded bore that contacts a mating seal surface of the fuel cup to form the upper seal.

6. The fuel injector assembly according to claim 4 further comprising a first upper seal member disposed about the upper housing, the first upper seal member contacting the upper housing and the fuel cup to form the upper seal.

7. The fuel injector assembly according to claim 6, wherein the first upper seal member is a resilient material.

8. The fuel injector assembly according to claim 6 further comprising a second upper seal member disposed about the upper housing, the second upper seal member contacting the upper housing and the fuel cup to form a second upper seal between the upper housing and the fuel cup, the first upper seal member being axially between the fuel inlet and the second upper seal member.

9. The fuel injector assembly according to claim 4 further comprising a lower seal between the upper housing and the fuel cup, the fuel inlet being disposed between the upper seal and the lower seal.

10. The fuel injector assembly according to claim 9 further comprising a first lower seal member disposed about the upper housing, the first lower seal member contacting the upper housing and the fuel cup to form the lower seal, wherein the first lower seal member is a resilient material.

11. The fuel injector assembly according to claim 10 further comprising a second lower seal member disposed about the upper housing, the second lower seal member contacting the upper housing and the fuel cup to form a second lower seal between the upper housing and the fuel cup, the first lower seal member being axially between the fuel inlet and the second lower seal member.

12. The fuel injector assembly according to claim 1, wherein the threaded bore is coaxial with a longitudinal axis of the fuel injector.

13. The fuel injector assembly according to claim 1 further comprising an orientation member, the orientation member engaging the fuel cup and the upper housing to inhibit rotation of the fuel injector relative to the fuel cup.

14. The fuel injector assembly according to claim 13, wherein the fuel cup defines an orientation aperture open through an exterior wall of the fuel cup, the orientation member extending through the orientation aperture and engaging the upper housing within the fuel cup when the upper housing is in a predetermined rotational alignment with the fuel cup.

15. The fuel injector assembly according to claim 14 further comprising an upper seal and a lower seal, the upper seal isolating the threaded bore from fluid communication with the fuel inlet, the lower seal isolating the orientation member from fluid communication with the fuel inlet.

16. A fuel injector assembly comprising:
a fuel rail;
a fuel cup coupled to the fuel rail, the fuel cup defining a cavity, a bolt bore, and a cup inlet, the bolt bore and cup inlet being open to the cavity, the cup inlet configured to receive fuel from the fuel rail;
a fuel injector including an injection tip and an upper housing, the injection tip defining a fuel outlet opposite the upper housing, the upper housing defining a fuel inlet and a threaded bore, wherein the fuel inlet is disposed within the cavity and in fluid communication with the cup inlet, wherein the threaded bore is disposed within the fuel cup;
a bolt extending through the bolt bore and threadably engaged with the threaded bore to couple the upper housing to the fuel cup; and
an upper seal inhibiting fluid communication from the cavity to an exterior of the fuel cup via the bolt bore.

17. The fuel injector assembly according to claim 16 further comprising a lower seal between the upper housing and the fuel cup, the fuel inlet being axially between the upper seal and the lower seal.

18. A fuel injector comprising:
an injection tip defining a fuel outlet; and
an upper housing opposite the fuel outlet, the upper housing being disposed about a longitudinal axis of the fuel injector, a distal portion of the upper housing being coupled to the injection tip, the upper housing defining a fuel inlet configured to receive fuel from a fuel rail, a proximal portion of the upper housing defining a threaded bore coaxial with the longitudinal axis.

19. The fuel injector according to claim 18 further comprising a seal surface disposed about the threaded bore and configured to sealingly engage a fuel cup.

20. The fuel injector according to claim 18 further comprising an upper seal member and a lower seal member, the upper seal member disposed about the upper housing and configured to form a seal with a fuel cup, the lower seal member disposed about the upper housing and configured to form a seal with the fuel cup, the fuel inlet being disposed axially between the upper and lower seal members.
